(19) United States
(12) Patent Application Publication
(10) Pub. No.: US 2011/0258956 A1
(43) Pub. Date: Oct. 27, 2011

(54) Natural Fiber Composite Construction Panel

(76) Inventor: Colin Felton, Coos Bay, OR (US)

(21) Appl. No.: 13/116,316

(22) Filed: May 26, 2011

(51) Int. Cl. E04D 1/22; B32B 29/00

(52) U.S. Cl. 52/518; 428/532

(57) ABSTRACT

A construction panel that contains polymer and natural plant fiber. The construction panel has an upper portion in which the polymer is recycled, and a lower portion in which the polymer is not contaminated. The upper portion may contain a large proportion of fire retardant material, so as to increase the burn-through rate. The construction panel can carry a low emissivity covering in non-exposed portions.

### FIELD

This disclosure relates to a natural fiber—polymer composite construction panel.

### BACKGROUND

Natural fiber—thermoplastic composites are commonly used in the manufacture of home decking products due to their environmental durability. This class of materials combines the positive attributes of wood or other natural fiber materials such as strength, stiffness, and low cost with the positive attributes of thermoplastics including moldability, weather-resistance, and aesthetics. Additives in relatively small amounts are often used to improve the properties of these materials. Typical additives include coupling agents to bond the plastic and fiber, UV stabilizers to prevent degradation of the plastic caused by exposure to sunlight, antioxidants or heat stabilizers to prevent degradation of the plastic due to heat and oxygen, pigments to obtain a desirable color, flame retardants to enable the product to meet building code requirements, and fungicides to prevent the biodegradation of the natural fibers.

These materials are normally blended in twin-screw extruders or internal batch mixers common in the plastics industry and then extruded, injection molded or compression molded into their desired shape.

Compression molding as a method to manufacture parts out of thermoplastics or thermoplastic composites allows for a significant amount of flexibility with regards to composition of the part and is commonly used in Europe to process recycled plastics. Different materials, initially molten, can be placed in different parts of the mold to satisfy performance requirements of different physical areas of the part. For example, automotive door panels are commonly molded out of recycled plastic with poor aesthetic characteristics but have an acceptable appearance by molding a layer of virgin polyvinyl chloride or colored fabric on the ‘show’ side of the mold and placing the recycled plastic on top of it so the resulting part has recycled resin on the non-visible side and a visually pleasing finish on the visible car interior side. In a similar way, the compression molding method can also be used to create a building construction panel that has an aesthetically pleasing appearance but meets stringent cost, fire and thermal performance demands due to characteristics of the materials molded into the non-visible portion of the product.

Most roofing materials used on inclined roofing applications as well as most siding products are installed starting from the lower portion of the roof or wall first and subsequent courses overlap the previous course to provide the weather resistance. FIG. 1 shows how shakes or shingles 10 are used to cover a roof 20. Roofing materials like wood shakes and shingles, slate, tile and asphalt shingles as well as most siding products are all installed in a similar fashion and all have a portion of the product that is visible after installation (exposure 12) and a portion that is not visible after installation (headlap 14). Due to manufacturing constraints, normally, the headlap and the exposure have the same composition whether they are synthetic or natural slate, tile, wood shakes or shingles or asphalt shingles.

### SUMMARY

Disclosed herein is a natural fiber—thermoplastic composite roofing or siding panel that simulates wood shakes/shingles, slate or tile and that has improved fire resistance, thermal resistance and cost relative to competitive roofing or siding materials with similar appearance, and a method of manufacturing the composite panel. The improved cost and enhanced fire and thermal resistance is achieved by utilizing the flexibility of compression molding for imparting multiple layers and/or materials with different compositions into a single part. Examples illustrate a potential reduction of 16° F. or more in roofing structure temperature, a 40% improvement in burning-brand performance, and a 20% reduction in panel cost.

This disclosure features a construction panel comprising an upper portion and a lower portion. The panel comprises:

(i) from about 30 percent to about 65 percent natural plant fiber; and

(ii) from about 25 percent to about 50 percent polymer.

The upper portion comprises from about 25 percent to about 50 percent recycled polymer. The construction panel may further comprise:

(iii) up to about 0.5 percent antioxidant;

(iv) up to about 0.5 percent UV stabilizer;

(v) up to about 5 percent coupling agent;

(vi) up to about 6 percent pigment;

(vii) up to about 25 percent fire retardant; and

(viii) up to about 1 percent fungicide.

The upper portion may comprise about 30 percent recycled polymer. The upper portion may comprise about 50 percent natural fiber polymer. The upper portion may comprise about 12 percent fire retardant. The upper portion may comprise about 2 percent coupling agent. The lower portion may comprise from about 2 percent to about 6 percent pigment, and the upper portion may comprise up to about 1 percent pigment. The lower portion may comprise about 34 percent non-contaminated polymer. The upper portion may comprise about 0 percent non-contaminated polymer and about 30 percent recycled polymer.

In another embodiment the upper portion may comprise:

(i) about 30 percent recycled polymer;

(ii) about 50 percent natural fiber;

(iii) about 2 percent coupling agent; and

(iv) about 12 percent fire retardant.

In this embodiment the lower portion may comprise:

(i) about 34 percent non-contaminated polymer;

(ii) about 55 percent natural fiber;

(iii) about 2 percent coupling agent;

(iv) about 4 percent pigment; and

(v) about 6 percent fire retardant.

In this embodiment the construction panel can be manufactured by compression molding. The construction panel may further comprise a low emissivity covering or a low emissivity formulation. The construction panel may comprise a low emissivity covering on non-exposed portions of the construction panel. The non-exposed portions with the low-emissivity covering may comprise the upper side of the upper portion of the construction panel, and the lower side of the lower portion of the construction panel. The low emissivity covering may comprise aluminum foil.

The construction panel may comprise a roofing panel or siding panel that simulates wood shakes, wood shingles, slate or tile. The upper portion may be the headlap of the panel and the lower portion may be the exposure of the panel.

Further featured herein is a roofing panel or siding panel that simulates wood shakes, wood shingles, slate or tile construction panel comprising an upper portion comprising the headlap of the panel and a lower portion comprising the exposure of the panel. The upper portion may comprise:

(i) about 30 percent recycled polymer;

(ii) about 50 percent natural fiber;

(iii) about 2 percent coupling agent; and

(iv) about 12 percent fire retardant.

The lower portion may comprise:

(i) about 34 percent non-contaminated polymer;

(ii) about 55 percent natural fiber;

(iii) about 2 percent coupling agent;

(iv) about 4 percent pigment; and

(v) about 6 percent fire retardant; and

The panel as a whole may comprise:

(i) up to about 0.5 percent antioxidant;

(ii) up to about 0.5 percent UV stabilizer;

(iii) up to about 5 percent coupling agent;

(iv) up to about 6 percent pigment;

(v) up to about 25 percent fire retardant; and

(vi) up to about 1 percent fungicide.

Still further featured herein is a roofing panel or siding panel that simulates wood shakes, wood shingles, slate or tile construction panel and is made by compression molding, the panel comprising an upper portion comprising the headlap of the panel and a lower portion comprising the exposure of the panel. The upper portion may comprise:

(i) about 30 percent recycled polymer;

(ii) about 50 percent natural fiber;

(iii) about 2 percent coupling agent; and

(iv) about 12 percent fire retardant

The lower portion may comprise:

(i) about 34 percent non-contaminated polymer;

(ii) about 55 percent natural fiber;

(iii) about 2 percent coupling agent;

(iv) about 4 percent pigment; and

(v) about 6 percent fire retardant;

The panel as a whole may comprise:

(i) up to about 0.5 percent antioxidant;

(ii) up to about 0.5 percent UV stabilizer;

(iii) up to about 5 percent coupling agent;

(iv) up to about 6 percent pigment;

(v) up to about 25 percent fire retardant; and

(vi) up to about 1 percent fungicide.

There may be a low emissivity covering on non-exposed portions of the construction panel, wherein the non-exposed portions with the low-emissivity covering comprise the upper side of the upper portion of the construction panel, and the lower side of the lower portion of the construction panel, and wherein the low emissivity covering comprises aluminum foil.

### BRIEF DESCRIPTION OF THE DRAWINGS

FIG. 1 is a schematic side view of a portion of a roof, illustrating the use of shakes or shingles to cover the roof, in accordance with the prior art;

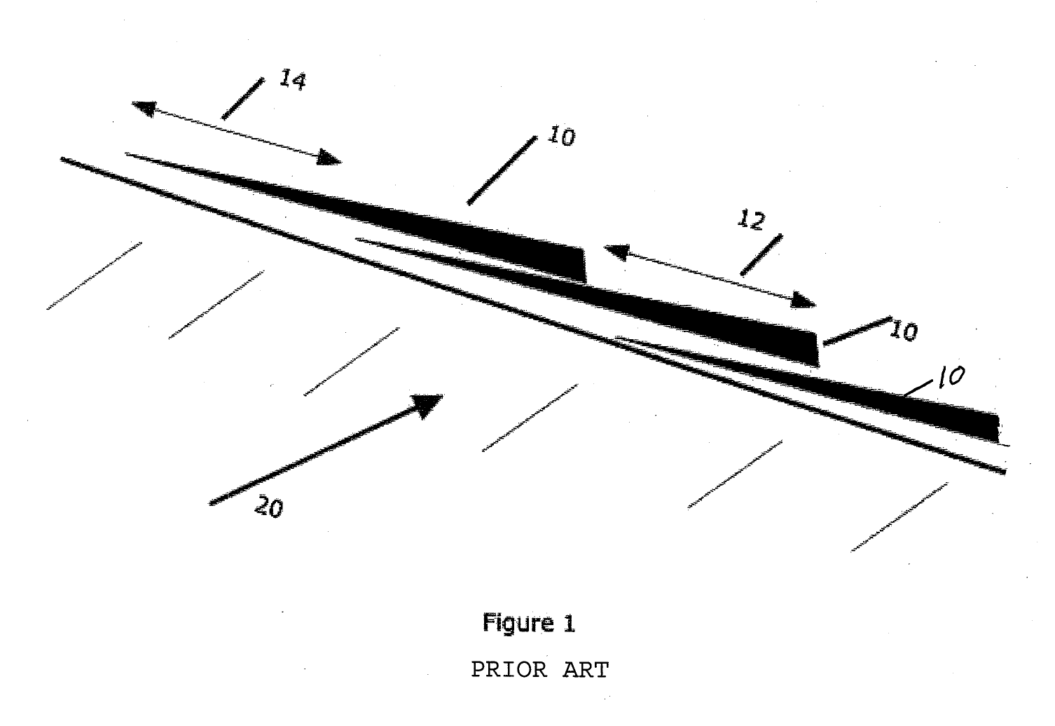

FIG. 2 is a schematic top view of a panel in accordance with a preferred embodiment of the invention;

FIG. 3 is a schematic side view of the inventive panel of FIG. 2;

FIG. 4 is a schematic side view of the inventive panel of FIG. 2, illustrating heat transfer through the panel;

FIG. 5 is a schematic illustration of the setup used to test the fire resistance of the inventive panel of FIG. 2; and

FIG. 6 is a schematic illustration of the setup used to test the thermal resistance of the inventive panel of FIG. 2.

### DETAILED DESCRIPTION

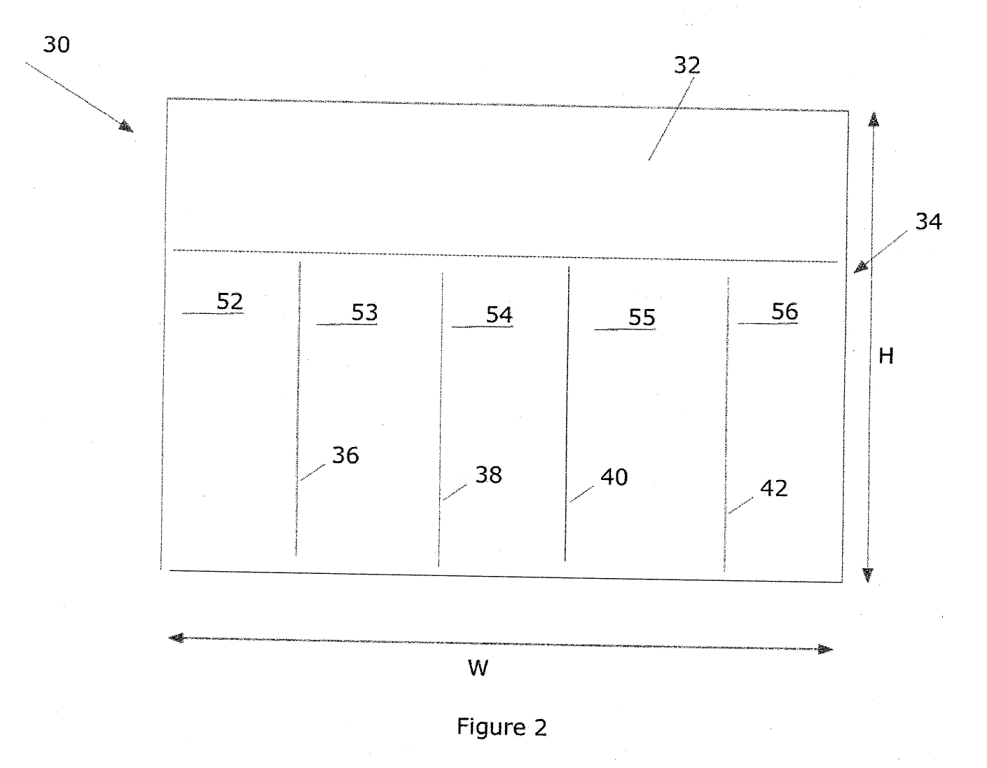

A construction panel manufactured out of natural fibers, thermoplastics and various additives to provide the necessary mechanical, aesthetic, fire and weatherability requirements for a commercially viable product. The panel is designed to mimic natural materials such as wood shingles or shakes, ceramic or clay tiles, or slate. Due to the capability of compression molding to easily form relatively flat and large parts, the construction panel is designed to copy the replicating nature of roofing materials with several tiles, shakes or shingles molded together into one panel. FIG. 2 shows the general physical appearance of panel 30 of the invention with a physical separation (or appearance of) between the individual tiles, shakes or shingles. Panel 30 comprises headlap area 32 and exposure area 34. There may be a line 44 molded into the panel to visually demarcate these two areas. Physical spaces or the appearance of physical spaces 36, 38, 40 and 42 define individual tiles, shakes or shingles 52-56. Panel width W can be any size, and is typically up to 6 feet, while height H can also be any size, and typically up to 3 feet.

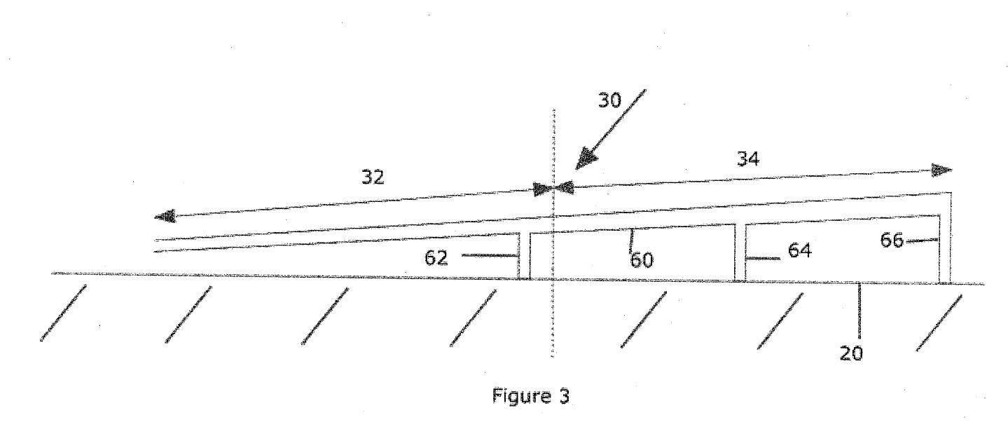

The inventive panel can incorporate any one or more of the following features. See FIGS. 2 and 3.
1) Headlap 32 is comprised of a formulation that utilizes low cost, recycled resins that would not normally meet the aesthetic requirements of the visible exposure 34 portion of a roof covering.
2) Exposure 34 is comprised of a formulation that utilizes pigments, UV stabilizers, and fungicides normally required for a product to be environmentally durable and maintain a standard of appearance in an exposed location,
3) Headlap 32 can be manufactured without all the additives required for weatherability of the exposure portion 34 of the roof covering such as UV stabilizers, pigments, and fungicides,
4) Headlap 32 can be manufactured out of a formulation containing a high level of fire retardant to improve the burning-brand fire resistance of the roof covering.
5) Headlap 32 can have a coating, or can be manufactured out of a formulation that has increased thermal reflectivity and low thermal emissivity to increase the heat transfer resistance of the roof covering.
6) Ribbed underside 60, which defines ribs 62, 64 and 66 of exposure 34 can be coated with or have a layer of material with a high ambient-temperature thermal reflectivity and low thermal emissivity to increase the heat transfer resistance of the roof covering.

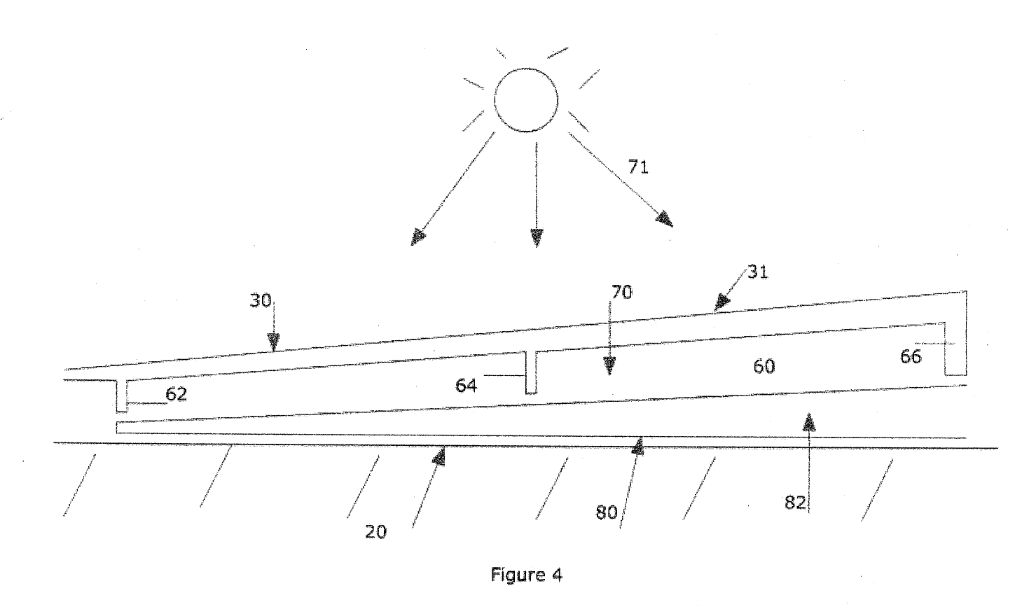

Many new roofing products are manufactured out of plastic and plastic composite materials and often have ribs on the underside to conserve material and reduce material cost as well as improve part cooling time in the mold. These ribs create an air-gap where radiation is the dominant heat transfer mechanism between the surface of the roofing material and the roof structure in situations with incident solar radiation. For these kinds of products, FIG. 4 shows how solar radiation 71 is first absorbed by the exposed surface 31 of panel 30, then transferred through to the underside 60 of the exposure 34 and then transferred to the headlap 82 of underlying panel 80 which sits on roof 20. This heat transfer is accomplished by radiation through the air-gap 70 and conduction through the ends of the ribs 62, 64 and 66. Heat absorbed by the headlap 82 is then readily transferred through conduction to the roof or wall structure 20 and into the attic or wall cavity. Reduction of the temperature of the headlap on a hot day will reduce the attic or wall interior temperature and reduce the building's cooling demand.

Typical building materials have ambient temperature thermal emissivities of at least 0.9 and so absorbed solar radiation is readily re-emitted as IR radiation. A significant amount of research and development effort is being expended on creating cool-roofs by using materials or coatings that have low absorbtivities for radiation in the solar spectra and high emissivities for infrared radiation at ambient temperatures. These materials, however, have been slow to enter the market due to their questionable aesthetic appeal even though they have the ability to reduce the roof surface temperature by as much as 50° F.

These same materials typically have high emissivities at ambient temperatures and therefore are not effective in preventing radiation being transferred between roofing layers. By contrast, metals, which are generally unacceptable on exposed building surfaces, often have ambient temperature emissivities below 0.3 as exemplified by paint containing aluminum particles (see Table 1). Aluminum containing materials or foils are commonly used in attics to reduce radiation heat transfer but are not currently used in roof coverings. The incorporation of low emissivity materials into non-visible areas of roofing and siding products with this invention should not inhibit the adoption of this energy-saving technology by consumers. Table 1 shows the emissivities of common building materials as well as aluminum, aluminum containing coatings and aluminum tape.

TABLE 1
Emissivities of building materials and radiation barrier materials

| Material | Emissivity | Temperature (° F.) |
|---|---|---|
| Building Materials | | |
| Red Brick | 0.93 | 70 |
| Concrete Tiles | 0.94 | 32-2000 |
| Paint (avg. of 16 colors) | 0.94 | 75 |
| Wood | 0.9 | 100 |
| Tar Paper | 0.93 | 68 |
| Aluminum Paints | | |
| 10% aluminum | 0.52 | 100 |
| 26% aluminum | 0.3 | 100 |
| Dow XP-310 | 0.22 | 200 |
| Metals | | |
| Unoxidized aluminum | 0.02 | 77 |
| Unoxidized steel | 0.08 | 212 |
| Galvanized zinc | 0.28 | 100 |
| 3M Type 425 aluminum tape | 0.03 | 100 |

In addition to improving the heat transfer resistance of the construction panel, the fire resistance of the panel can be improved. For roof coverings the composition of the exposure determines the flame spread characteristics (ASTM E108) of the product while the burn-through or burning brand characteristic (ASTM E108) are determined by the overall composition of the product and to a great effect the composition of the headlap. The burning-brand test involves starting a fire on the top of a roof covering and measuring the time before the fire burns through to the underside of the roof. With natural fiber thermoplastic composites it is common that the limiting test with regards to fire retardant composition is the burning-brand test. The amount of flame retardant necessary to meet the flame spread requirement is generally not sufficient to Meet the burning-brand requirements with natural fiber—thermoplastic composites. The incorporation of a larger amount of fire-retardant in the headlap than is necessary to meet the flame-spread requirements of the exposure will result in a less-costly product because excess fire-retardant will not be wasted in the exposure.

### EXAMPLES

### Example 1

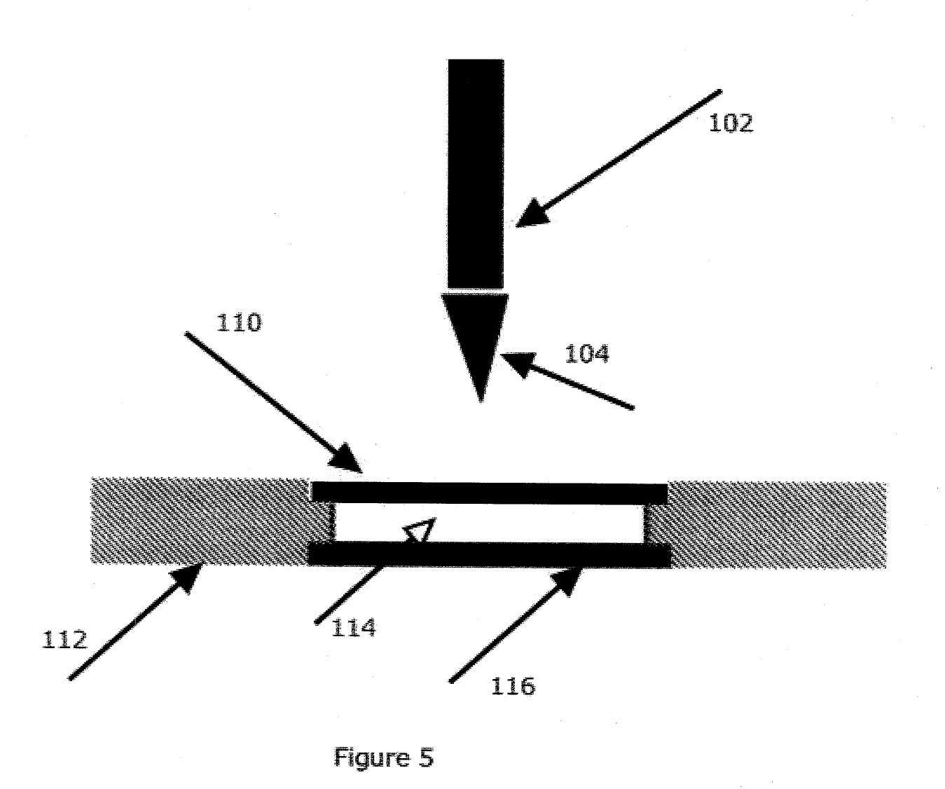

Example 1 demonstrates the improved burning brand fire resistance of a panel with more fire retardant in only the headlap portion of the panels comprising a roof covering. The burning-brand test is simulated with laboratory-sized samples through the use of a MAPP torch 102 with flame 104 as shown in FIG. 5. Table 2 lists the formulations used for the headlap and the exposure used in Example 1.

The formulations in Table 2 for the headlap and exposure of a roof covering are used to illustrate the burning-brand fire resistance advantage of the present invention.

TABLE 2
Example formulations illustrating enhance fire resistance (wt. %)

| | | Headlap | Headlap |
|---|---|---|---|
| Ingredient | Exposure | (standard) | (enhanced) |
| Light Stabilizer⁽¹⁾ | 0.1 | 0.1 | 0.1 |
| Antioxidant⁽²⁾ | 0.1 | 0.1 | 0.1 |
| Pigment⁽³⁾ | 4 | 4 | 0 |
| Fire retardant⁽⁴⁾ | 5 | 5 | 15 |
| Natural Fiber⁽⁵⁾ | 55 | 55 | 49 |
| Coupling Agent⁽⁶⁾ | 2 | 2 | 2 |
| Polymer⁽⁷⁾ | 33.8 | 33.8 | 33.8 |
| Fungicide⁽⁸⁾ | 0 | 0 | 0 |
| TOTAL | 100 | 100 | 100 |

⁽¹⁾Ciba Geigy 783 FDL
⁽²⁾Ciba Geigy B225
⁽³⁾Bayferrox 318M iron oxide
⁽⁴⁾Martin Marietta Magshield S magnesium hydroxide
⁽⁵⁾Rice Hull Specialty Co. 20/80 rice hulls
⁽⁶⁾DuPont MB226D maleic acid grafted LLDPE
⁽⁷⁾3 MFI HDPE copolymer
⁽⁸⁾US Borax Firebrake ZB zinc borate

The formulations in Table 2 were mixed in a Brabender mixer with a small (60 cc) mix head with roller blades and discharged as a contiguous billet at 400° F. by reversing the direction of the blades. The 400° F. billets were placed in an open mold maintained at 150° F. in a 4 ton carver hydraulic press and compression molded into ⅛″ thick×2″ diameter discs.

The setup is shown in FIG. 5. Flame 104 was about 1″ from top plaque 110. Non-combustible cement board (⅜″ thick) 112 with hole 114 therein held the two plaques apart. Lower plaque 116 is thus spaced from upper plaque 110. In the control configuration a plaque with the standard headlap formulation was stacked above a plaque of the same dimensions and composition and a MAPP gas torch was applied to the top surface as shown in FIG. 5. The burn-through rate was 1.08±0.04 minutes, measured by the first appearance of smoke on the underside of the bottom plaque 116. In the second configuration a plaque with the standard exposure formulation was stacked above an enhanced fire resistance headlap plaque of the same dimensions and the burn through rate time was measured to be 1.27±0.05 minutes. This difference is a 15% improvement in burn-through time and is an indication of the relative performance in an actual ASTM E108 burning brand test where seconds in burn-through time can make the difference in passing the test or not.

### Example 2

The formulations in Table 3 for the headlap and exposure of a roof or siding covering were used to illustrate the enhanced thermal resistance of the inventive panel.

TABLE 3
Example formulations illustrating
enhanced thermal resistance (wt. %)

| Ingredient | Exposure | Headlap |
|---|---|---|
| Pigment⁽¹⁾ | 4 | 4 |
| Fire retardant⁽²⁾ | 5 | 5 |
| Natural Fiber⁽³⁾ | 55 | 55 |
| Coupling Agent⁽⁴⁾ | 2 | 2 |
| Polymer⁽⁵⁾ | 34 | 34 |
| TOTAL | 100 | 100 |

⁽¹⁾Bayer Bayferrox 318M black iron oxide
⁽²⁾Martin Marietta Magshield S magnesium hydroxide
⁽³⁾Kenaf Industries chopped bast fiber
⁽⁴⁾Chemtura Polybond 3200 maleic acid grafted polypropylene
⁽⁵⁾10 MFI polypropylene homopolymer

The formulations in Table 3 were mixed in a Brabender mixer with a small (60 cc) mix head with roller blades and discharged as a contiguous billet at 400° F. by reversing the direction of the blades. The 400° F. billets were placed in an open mold maintained at 150° F. in a 4 ton carver hydraulic press and compression molded into ⅛″ thick×2″ diameter discs.

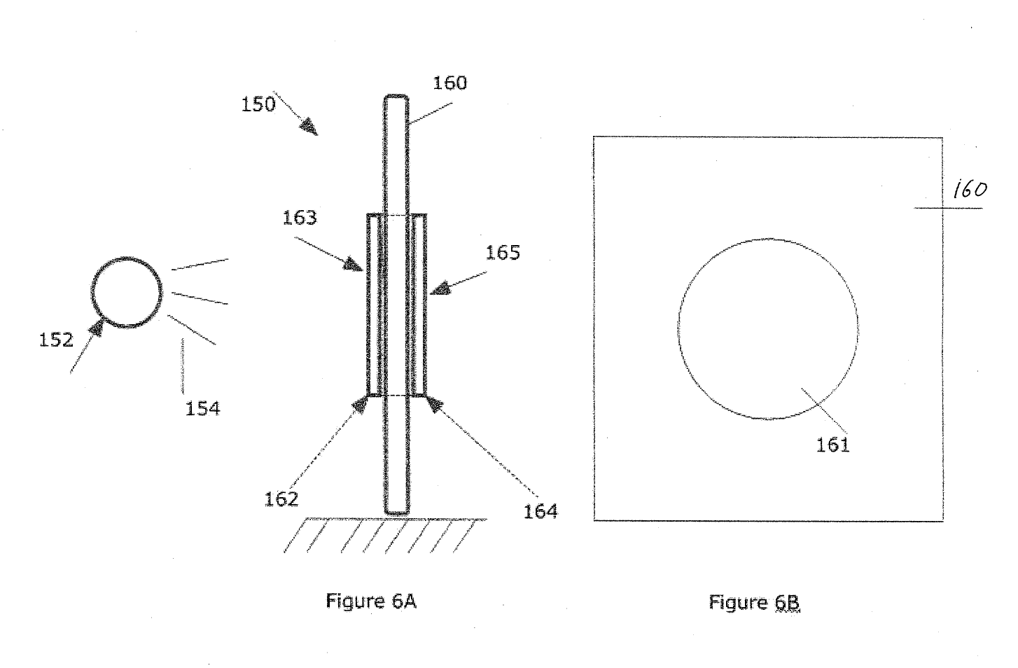

Three different variations of the experiment were performed to demonstrate how a layer of low-emissivity material on the inside surface of the plaques would slow heat transfer through the set of plaques designed to simulate the roofing layer shown in FIG. 4. Table 4 gives the experimental results of the three scenarios. See FIG. 6 for the experimental setup.

TABLE 4
Heat transfer conditions for example 2.

| | Temperature⁽¹⁾ of | Temperature⁽¹⁾ of | Temperature |
|---|---|---|---|
| | outside surface of | outside surface of | difference |
| Condition | disc (c) (° F.) | disc (d) (° F.) | (° F.) |
| No foil⁽²⁾ layer | 177 | 116 | 61 |
| (control) | | | |
| Foil layer on | 179 | 103 | 76 |
| unexposed side of | | | |
| disc 110 | | | |
| Foil layer on | 184 | 100 | 84 |
| unexposed sides of | | | |
| discs 110 and 116 | | | |

⁽¹⁾measured with Omega OS540 infrared thermometer.
⁽²⁾3M Type 425 aluminum foil tape (emissivity = 0.03) typically used for heating & air conditioning ductwork.

Results show that with a foil or other highly reflective coating on the top surface of the headlap and on the ribbed underside of a roof panel, heat transfer through the surfaces can be significantly reduced as exemplified by a 15-23 ° F. lowering of the underside of the simulated roof covering.

The thermal radiation test apparatus 150, FIG. 6, consisted of a 200 watt halogen light bulb 152 which emits thermal radiation 154. ⅛″ composite discs 162 and 164 with outer faces 163 and 165, respectively, are separated by a ¼″ thick piece of cardboard 160 with hole 161 through. Incident heat heats surface 163 and is transferred via radiation to disc 164 and transferred by conduction to surface 165. In the setup illustrated in FIG. 6, it is acknowledged that thermal convection exists between the discs and on the outside of the discs. The setup in FIG. 6 is considered a worst-case scenario because it is commonly known that free-convection on vertically oriented surfaces is several times greater than free-convection on horizontally oriented heated surfaces which would more accurately represent the situation in a roofing application. The measured temperature difference of between 15 and 23° F. is therefore considered to be an underestimate of what would occur in a real application. In cool-roof installations, roof temperature reductions of 40° F. to 50° F. are desired and achievable at significant expense. The significance of this invention is that a significant roof temperature reduction is likely to be achieved at a minimal cost.

To calculate the associated reduction in heat flux associated with this temperature reduction, the situation can be approximated with the equation for radiative heat transfer between two gray bodies:

$$\dot{Q} = {( \frac{1 - {ɛ}_{1}}{{ɛ}_{1}} + \frac{{A}_{1} + {A}_{2} - 2 {A}_{1} {F}_{12}}{{A}_{2} - {{A}_{1} ( {F}_{12} )}^{2}} + ( \frac{1 - {ɛ}_{2}}{{ɛ}_{2}} ) \frac{{A}_{1}}{{A}_{2}} )}^{- 1} {A}_{1} σ ( {T}_{1}^{4} - {T}_{2}^{4} )$$

where:
Q=heat flux
A1=surface area of higher temperature surface (2″ diameter disc)
A2=surface area of lower temperature surface (2″ diameter disc)
F12=view factor between two surfaces (estimated to be 0.99 for this situation).
T1=temperature of higher temperature surface
T2=temperature of lower temperature surface
ε₁=infrared emissivity of higher temperature surface
ε₂=infrared emissivity of lower temperature surface

Using the data in Table 4 and emissivities of 0.94 and 0.03 for the uncoated and coated composites, respectively, a reduction in heat flux of 0.047 watts is achievable, which is a 20% reduction due to the application of aluminum tape on the inside surfaces of the discs.

### Example 3

Example 3 shows the cost savings associated with a headlap that uses recycled polymer without expensive pigments, UV and heat stabilizers

TABLE 5
Example illustrating cost savings with recycled resin (wt. %)

| | Ingredient | Standard headlap | Standard headlap | Low-Cost headlap | Low-cost headlap |
|---|---|---|---|---|---|
| Ingredient | Cost ($/LB) | (composition wt. %) | material Cost ($/LB) | (composition wt. %) | material Cost ($/LB) |
| Light Stabilizer⁽¹⁾ | 10 | 0.1 | 0.010 | 0 | 0 |
| Antioxidant⁽²⁾ | 4 | 0.1 | 0.004 | 0 | 0 |
| Pigment⁽³⁾ | 2 | 4 | 0.080 | 0 | 0 |
| Fire retardant⁽⁴⁾ | 0.75 | 5 | 0.053 | 10 | 0.05 |
| Natural Fiber⁽⁵⁾ | 0.1 | 54 | 0.052 | 53.2 | 0.06 |
| Coupling Agent⁽⁶⁾ | 2.5 | 2 | 0.050 | 2 | 0.05 |
| Polymer⁽⁷⁾ | 0.5 | 33.8 | 0.169 | 0 | 0 |
| Recycled Polymer⁽⁸⁾ | 0.15 | 0 | 0.000 | 33.8 | 0.05 |
| Fungicide⁽⁹⁾ | 1.5 | 1 | 0.015 | 1 | 0.02 |
| TOTAL | | 100 | 0.43 | 100 | 0.23 |

⁽¹⁾Ciba Geigy 783 FDL
⁽²⁾Ciba Geigy B225
⁽³⁾Bayferrox 318M iron oxide
⁽⁴⁾Martin Marietta Magshield S magnesium hydroxide
⁽⁵⁾Rice Hull Specialty Co. 16/80 rice hulls
⁽⁶⁾DuPont MB226D maleic acid grafted LLDPE
⁽⁷⁾3 MFI HDPE copolymer
⁽⁸⁾Recycled John Deere Model 505 T-Tape Drip Tape (HDPE with Carbon Black pigment)
⁽⁹⁾US Borax Firebrake ZB zinc borate

The formulations in Table 5 were mixed in a Brabender mixer with a small (60 cc) mix head with roller blades and discharged as a contiguous billet at 400° F. by reversing the direction of the blades. The 400° F. billets were placed in an open mold maintained at 150° F. in a 4 ton carver hydraulic press and compression molded into ⅛″ thick×2″ diameter discs. In both the low-cost headlap formulation and the standard formulation the 4 ton hydraulic press was able to press out an acceptable plaque the thickness of the ¼″ mold cavity. The plaque made from the low cost material was approximately ½ the cost of the standard headlap material.

For a roofing or siding panel where the headlap weighs approximately 3.33 lbs and the exposure weighs 6.67 lbs, this corresponds to a material cost savings of 16%. With compression molding material costs at 70 to 80% of the product manufacturing cost, the 16% savings in material cost is significant.

For a roofing panel 44″ wide×22″ tall that weighs approximately 9 lbs, a panel with the exposed composition in the exposure portion of the panel and the headlap composition in the headlap part of the panel can be prepared by:

1) placing a 42″ long×3″ wide×1″ tall billet at 400° F. comprised of a formulation appropriate for the exposure over the exposure portion of an open compression mold with the textured half of the mold on the bottom, maintained at 180° F. and oriented in the horizontal plane.
2) placing a 42″ long×3″ wide×0.5″ tall billet at 400° F. comprised of a formulation appropriate for the headlap over the headlap portion of the same compression mold in (1).
3) closing the mold in a press capable of a pressure of at least 1000 psi and distributing the molten composite throughout the mold cavity.
4) keeping the mold closed under pressure and allowing the composite material to cool to near the mold temperature of 180° F. (approximately 1 minute).
5) opening the mold, removing the panel and allowing the panel to air-cool to ambient temperature (approximately 15 minutes).

To make a panel with a headlap or exposure comprised of layers, the same method to make the panel above can be used, except that molten sheets are strategically placed in layers in the open mold instead of billets placed side by side. For example, a panel with a high reflectivity on the top side of the headlap could be made by:

1) placing a 42″ long×3″ wide×1″ tall billet at 400° F. comprised of a formulation appropriate for the exposure over the exposure portion of an open compression mold with the textured half of the mold on the bottom, maintained at 180° F. and oriented in the horizontal plane.
2) placing a 44″ long×12″ wide×0.025″ thick sheet at 400° F. comprised of a formulation appropriate for the headlap but with normal thermal reflectivity over the headlap portion of the same compression mold in (1).
3) placing a 44″ long×12″ wide×0.095″ thick sheet at 400° F. comprised of a formulation appropriate for the headlap but containing a material with a high-reflectivity (such as aluminum powder) on top of the molten sheet material in (2) above.
4) closing the mold in a press capable of a pressure of at least 1000 psi and distributing the molten composite throughout the mold cavity.
5) keeping the mold closed under pressure and allowing the composite material to cool to near the mold temperature of 180° F. (approximately 1 minute).
6) opening the mold, removing the panel and allowing the panel to air-cool to ambient temperature (approximately 15 minutes).

### INGREDIENTS

Preferred natural fibers used in the invention may include wood flour, sugar cane bagasse, hemp, coconut coir, jute, kenaf, sisal, flax, coir pith, rice-hulls, banana stalk fiber, pineapple leaf fiber, flax, coir pith, cotton and straw and seed hulls, husks or shells from grain or nut production. The natural fibers in the formulation are added to improve stiffness, reduce thermal expansion and contraction, reduce cost and for their intumescent fire retardant properties.

Preferred polymers used in the invention include polyvinyl chloride, polypropylene, low and high density polyethylene and their copolymers as well as polyethylene terephthalate and polystyrene. Any of these polymers listed above that are mixed together or contaminated with dirt, EVA, pigment, non-miscible thermoplastics, paper, or particles and that might affect appearance can be used in the headlap portion of the roofing panel while pure, uncontaminated resins with minimal pigmentation or contamination would be appropriate for the exposed portion of the product. Polymers are added to provide a moldable matrix for the other ingredients in the composition as well as to seal the natural fibers from excessive moisture absorption and fungal degradation and improve fire resistance. The melt flow index of the polymer is selected to allow flow of the molten mixture under a reasonable amount of pressure commonly available in hydraulic presses (<50000 psi) and to be as low as possible because lower-melt flow resins have better impact properties and lower-melt flow plastics (typically with higher molecular weight) are more readily available as post-industrial and post consumer packaging scrap.

Preferred coupling agents used in the invention include maleic anhydride or maleic acid grafted variations of the resins listed above, silane compounds and any other compound typically used to bond hydrophilic additives to hydrophobic resins in composite formulations.

Preferred fire retardants used in the invention include aluminum hydroxide, magnesium hydroxide, zinc borate, boric acid and sodium octaborate or any combination of or any other inorganic endothermic, water-evolving fire retardant.

Preferred pigments used in the invention include oxides of iron, zinc, magnesium, titanium, copper, manganese, and mixtures thereof as well as carbon black. While other inventions (e.g., U.S. Pat. No. 6,983,571) include pigments in lower concentrations (<2%) so that the product fades naturally with time, the present invention includes sufficient pigment in the exposure to prevent significant fading. The light-stable pigments in the formulation function by absorbing or reflecting solar ultraviolet radiation and shielding the polymer and natural fibers from exposure and potential degradation.

Preferred antioxidants used in the invention include phenolic and/or phosphite compounds and mixtures thereof in amounts between 0 and 0.5% of the polymer content and are used to prevent or reduce the degradation of the resin in the presence of oxygen and high process or environmental temperatures.

Preferred UV stabilizers used in the invention include benzophenone compounds, hindered amine light stabilizers (HALS), benzotriazole compounds, and mixtures thereof, in amounts between 0.1 and 0.5% of the polymer content. These compounds are used to prevent degradation of the polymer due to solar ultraviolet radiation exposure.

Preferred fungicides used in the invention include boric acid, zinc borate, sodium octaborate and mixtures thereof. These fungicides can reduce the degradation of the natural fibers in the composite formulation from brown or white-rot fungi commonly present in shady and moist installation areas of roofing or siding products.

Preferred low emissivity materials used in the invention include any layer, tape or coating containing metals or materials with emissivities between 0° F. and 200° F. of <0.5. Some of the more cost effective examples include aluminum foil tape, aluminum foil, aluminum powder containing paint and recycled aluminum can flakes.

Table 6 includes the ranges and preferred amounts of certain ingredients of the headlap and exposure of embodiments of the inventive panel.

TABLE 6
Summary of ingredient composition for headlap and exposure⁽¹⁾.

| Ingredient | Headlap | Exposure |
|---|---|---|
| Antioxidant | 0.1-0.5/0 | 0.1-0.5/0 |
| UV Stabilizer | 0-0.1/0 | 0.1-0.5/0 |
| Coupling agent | 0-5/2 | 0-5/2 |
| Pigment | 0-1/0 | 2-6/4 |
| Non-contaminated polymer | 25-50/0 | 25-50/34 |
| Recycled polymer | 25-50/31 | 25-50/0 |
| Natural fiber | 30-65/52 | 30-65/55 |
| Fire retardant | 0-25/12 | 0-15/6 |
| Fungicide | 0-1/0 | 0-1/0 |

⁽¹⁾Key: minimum-maximum/most favored in weight % (dry basis).

What is claimed is:

1. A construction panel, comprising:
an upper portion; and
a lower portion;
wherein the panel comprises:
(i) from about 30 percent to about 65 percent natural plant fiber; and
(ii) from about 25 percent to about 50 percent polymer; and
wherein the upper portion comprises from about 25 percent to about 50 percent recycled polymer.

2. The construction panel of claim 1 further comprising:
(iii) up to about 0.5 percent antioxidant;
(iv) up to about 0.5 percent UV stabilizer;
(v) up to about 5 percent coupling agent;
(vi) up to about 6 percent pigment;
(vii) up to about 25 percent fire retardant; and
(viii) up to about 1 percent fungicide.

3. The construction panel of claim 1 wherein the upper portion comprises about 30 percent recycled polymer.

4. The construction panel of claim 3 wherein the upper portion comprises about 50 percent natural fiber polymer.

5. The construction panel of claim 4 wherein the upper portion comprises about 12 percent fire retardant.

6. The construction panel of claim 5 wherein the upper portion comprises about 2 percent coupling agent.

7. The construction panel of claim 1 wherein the lower portion comprises from about 2 percent to about 6 percent pigment, and the upper portion comprises up to about 1 percent pigment.

8. The construction panel of claim 1 wherein the lower portion comprises about 34 percent non-contaminated polymer.

9. The construction panel of claim 8 wherein the upper portion comprises about 0 percent non-contaminated polymer and about 30 percent recycled polymer.

10. The construction panel of claim 1 wherein the upper portion comprises:
(i) about 30 percent recycled polymer;
(ii) about 50 percent natural fiber;
(iii) about 2 percent coupling agent; and
(iv) about 12 percent fire retardant.

11. The construction panel of claim 10 wherein the lower portion comprises:
(i) about 34 percent non-contaminated polymer;
(ii) about 55 percent natural fiber;
(iii) about 2 percent coupling agent;
(iv) about 4 percent pigment; and
(v) about 6 percent fire retardant.

12. The construction panel of claim 11 made by compression molding.

13. The construction panel of claim 1 further comprising a low emissivity covering or a low emissivity formulation.

14. The construction panel of claim 13 comprising a low emissivity covering on non-exposed portions of the construction panel.

15. The construction panel of claim 14 wherein the non-exposed portions with the low-emissivity covering comprise the upper side of the upper portion of the construction panel, and the lower side of the lower portion of the construction panel.

16. The construction panel of claim 15 wherein the low emissivity covering comprises aluminum foil.

17. The construction panel of claim 1 comprising a roofing panel or siding panel that simulates wood shakes, wood shingles, slate or tile.

18. The construction panel of claim 17 wherein the upper portion is the headlap of the panel and the lower portion is the exposure of the panel.

19. A roofing panel or siding panel that simulates wood shakes, wood shingles, slate or tile construction panel, comprising:
an upper portion comprising the headlap of the panel; and
a lower portion comprising the exposure of the panel;
wherein the upper portion comprises:
(i) about 30 percent recycled polymer;
(ii) about 50 percent natural fiber;
(iii) about 2 percent coupling agent; and
(iv) about 12 percent fire retardant
wherein the lower portion comprises:
(i) about 34 percent non-contaminated polymer;
(ii) about 55 percent natural fiber;
(iii) about 2 percent coupling agent;
(iv) about 4 percent pigment; and
(v) about 6 percent fire retardant; and
wherein the panel comprises:
(i) up to about 0.5 percent antioxidant;
(ii) up to about 0.5 percent UV stabilizer;
(iii) up to about 5 percent coupling agent;
(iv) up to about 6 percent pigment;
(v) up to about 25 percent fire retardant; and
(vi) up to about 1 percent fungicide.

20. A roofing panel or siding panel that simulates wood shakes, wood shingles, slate or tile construction panel and is made by compression molding, the panel comprising:
an upper portion comprising the headlap of the panel; and
a lower portion comprising the exposure of the panel;
wherein the upper portion comprises:
(i) about 30 percent recycled polymer;
(ii) about 50 percent natural fiber;
(iii) about 2 percent coupling agent; and
(iv) about 12 percent fire retardant
wherein the lower portion comprises:
(i) about 34 percent non-contaminated polymer;
(ii) about 55 percent natural fiber;
(iii) about 2 percent coupling agent;
(iv) about 4 percent pigment; and
(v) about 6 percent fire retardant;
wherein the panel comprises:
(i) up to about 0.5 percent antioxidant;
(ii) up to about 0.5 percent UV stabilizer;
(iii) up to about 5 percent coupling agent;
(iv) up to about 6 percent pigment;
(v) up to about 25 percent fire retardant; and
(vi) up to about 1 percent fungicide; and
a low emissivity covering on non-exposed portions of the construction panel, wherein the non-exposed portions with the low-emissivity covering comprise the upper side of the upper portion of the construction panel, and the lower side of the lower portion of the construction panel, wherein the low emissivity covering comprises aluminum foil.
